(19) United States
(12) Patent Application Publication
(10) Pub. No.: US 2020/0314549 A1
(43) Pub. Date: Oct. 1, 2020

(54) Speaker

(71) Applicant: AAC Technologies Pte. Ltd., Singapore city (SG)

(72) Inventors: Hongjian Hu, Shenzhen (CN); Shuai Li, Shenzhen (CN)

(21) Appl. No.: 16/727,970

(22) Filed: Dec. 27, 2019

(30) Foreign Application Priority Data
Mar. 29, 2019 (CN) 201920416118.0

(51) Int. Cl. H04R 9/06; H04R 9/02; H04R 7/18; H04R 7/12

(52) U.S. Cl. CPC H04R 9/06; H04R 9/025; H04R 2400/11; H04R 7/12; H04R 7/18

(57) ABSTRACT

The present invention discloses a speaker having a frame, a vibrating system and a magnetic circuit system both fixed on the frame. The vibrating system having a diaphragm fixed on the frame and a voice coil for driving the diaphragm to vibrate and produce sound. The frame has a side wall for forming a receiving space, and the side wall includes a top plane fixedly connected with the diaphragm. An angle between the top plane and a vibrating direction of the vibrating system close to both the receiving space and the diaphragm is an obtuse angle or an acute angle. Compared with the related art, the speaker of the present invention has advantages of excellent acoustic performance and better reliability.

### FIELD OF THE PRESENT INVENTION

The present invention relates to the field of electronic equipment technology, and more particularly to a speaker.

### DESCRIPTION OF RELATED ART

With the advent of the mobile Internet era, the number of smart mobile devices is continuously increasing. Among numerous mobile devices, mobile phones are undoubtedly the most common and portable mobile terminal devices. At present, mobile phones have diverse functions, one of which is a high-quality music function, and a speaker in a mobile phone is one of necessary conditions to achieve the high-quality music function.

A related speaker has a frame and a diaphragm attached on the frame. With the development of miniaturization of a product, the speaker is required to be thinner and thinner so that an adhesive width on the connection between a frame and a diaphragm becomes smaller, thus the frame will easily fall from the diaphragm due to poor fastness, which directly affects the acoustic performance of the speaker.

Therefore, it is desired to provide a new speaker which can overcome the above-mentioned problems.

### SUMMARY OF THE PRESENT INVENTION

The purpose of the present invention is to overcome the above-mentioned problems by providing a speaker with a stronger combination structure for the frame with the diaphragm.

To achieve the above purpose, the present invention disclosures a speaker comprising a frame, a vibrating system and a magnetic circuit system both fixed on the frame. The vibrating system includes a diaphragm fixed on the frame and a voice coil for driving the diaphragm for vibrating and producing sound. The frame includes side wall for forming a receiving space. The side wall includes a top plane fixedly connected with the diaphragm, an angle between the top plane and a vibrating direction of the vibrating system close to both the receiving space and the diaphragm is an obtuse angle or an acute angle.

Preferably, the diaphragm includes a vibrating portion, a middle portion located on an inner circumference of the vibrating portion, a fixing portion fixedly connected with the top plane and a transition portion arranged on an outer circumference of the vibrating portion and connected the vibrating portion with the fixing portion. A surface of the fixing portion matches the shape of the top plane.

Preferably, the angle is an obtuse angle. The top plane includes an inner edge arranged close to the voice coil and an outer edge arranged away from the voice coil, and the fixing portion extends from the inner edge toward the outer edge and toward a direction of the diaphragm.

Preferably, the angle is an acute angle. The top plane includes an inner edge arranged close to the voice coil and an outer edge arranged away from the voice coil, and the fixing portion extends from the inner edge toward the outer edge and away from the direction of the diaphragm.

Preferably, the magnetic circuit system includes a yoke fixed on the frame, a main magnet fixed on the yoke, a secondary magnet arranged surrounding the main magnet and a secondary pole portion attached to the surface of the secondary magnet. The secondary pole portion is an annular configuration that matches with the shape of the frame and the secondary pole portion is fixedly connected with the frame.

Preferably, the secondary pole portion is provided with locating holes penetrating the secondary pole portion along the vibrating direction of the vibrating system, locating blocks matching with the shape of the locating holes are arranged on the position of the frame corresponding to the locating holes. The locating blocks are fixed on the locating holes.

Preferably, the secondary pole portion includes two longitudinal sides spaced apart from each other and two lateral sides for forming a ring structure together with the two longitudinal sides. The locating holes are arranged on the longitudinal sides of the secondary pole.

Preferably, the secondary magnet includes a magnetic extending portion extending along an intermediate position of the longitudinal side of the secondary magnet toward the main magnet and spaced apart from the main magnet. The secondary pole portion includes a pole extending portion arranged on the magnetic extending portion. The pole extending portion horizontally extends from the secondary pole portion along an intermediate position of the longitudinal side of the secondary pole portion toward the main magnet.

The speaker according to claim 1, wherein the diaphragm is fixed on the frame by gluing.

Compared with the related art, in the speaker of the present invention, the angle between the top plane and the vibrating direction of the vibrating system close to both the receiving space and the diaphragm is configured as an acute angle or an obtuse angle. Therefore an effective bonding width of the frame and the diaphragm is increased and a fixing strength between the both is strengthened, thus the possibility of the frame falling off and separating from the diaphragm is reduced, thereby improving a structural reliability and stability of the speaker provided by the present invention.

### BRIEF DESCRIPTION OF THE DRAWINGS

The embodiment of the present invention will be more clearly understood from the following drawings. It is obvious that the following described drawings are barely some embodiments of the invention. For the person skilled in the art, he can achieve the other drawings from these drawings without any creative work.

FIG. 1 is an illustrative assembled view of a speaker according to the present invention.

FIG. 2 is an illustrative exploded view of the speaker according to the present invention.

FIG. 3 is a cross-sectional view of the speaker taken along a line III-III in FIG. 1.

FIG. 4 is an enlarged view of section IV in FIG. 3.

FIG. 5 is a schematic view of an angle between a vibrating direction of a vibrating system and a top plane in FIG. 4.

### DETAILED DESCRIPTION OF THE EXEMPLARY EMBODIMENT

The technical solution in the embodiments of the invention will be clearly and completely described by combining with the drawings in the embodiments of the invention. Apparently, the described embodiments are only parts of the embodiments of the invention, but not all of the embodiments. Based on these embodiments, all the other embodiments that the person skilled in the art can achieve without making creative work, are belongitudinal to the scope of protection of the invention.

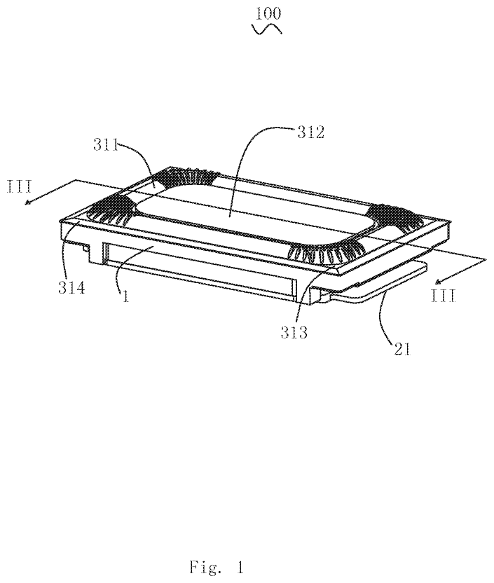

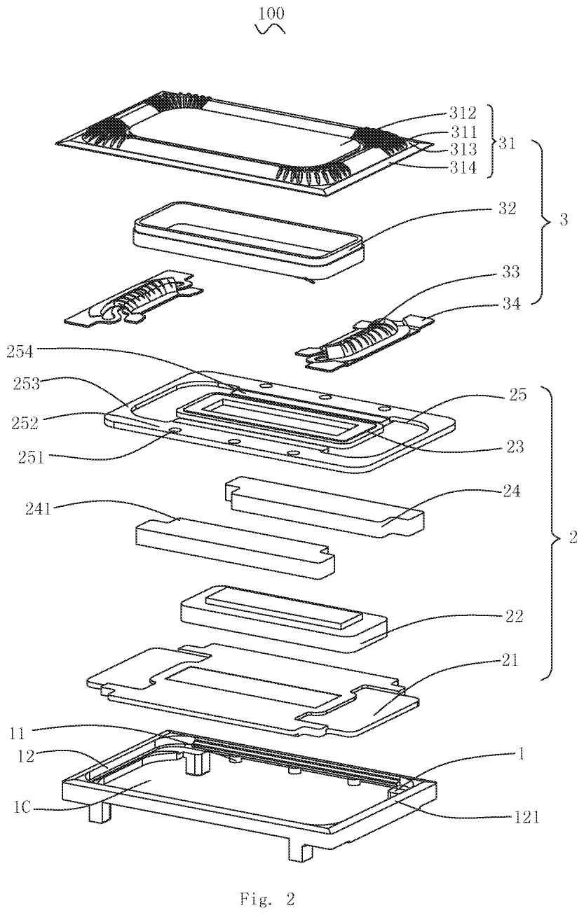

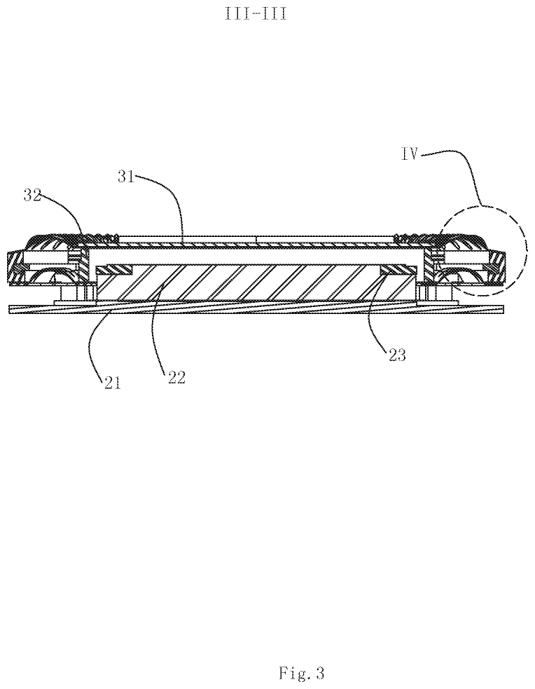

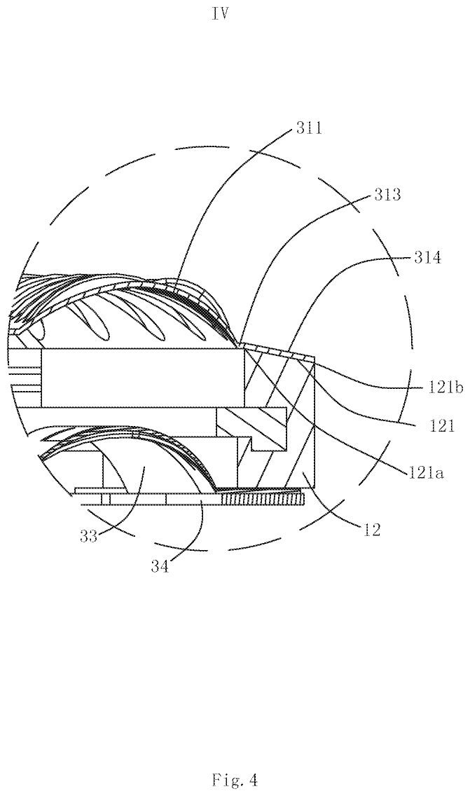

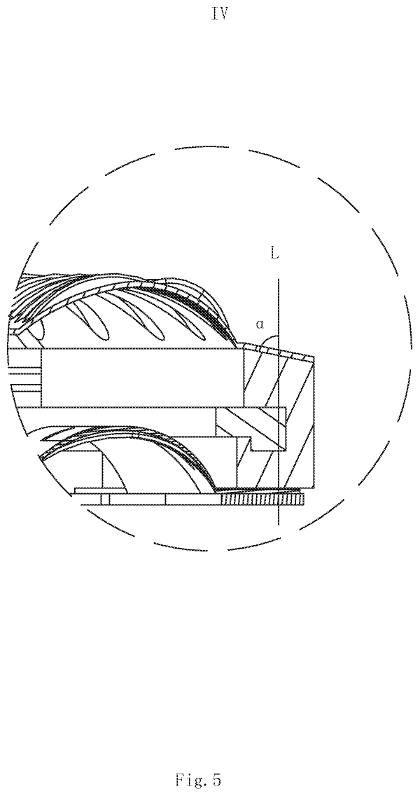

Referring to FIGS. 1-5, FIG. 1 is an illustrative assembled view of a speaker according to the present invention. FIG. 2 is an illustrative exploded view of the speaker according to the present invention. FIG. 3 is a cross-sectional view of the speaker taken along a line III-III in FIG. 1. FIG. 4 is an enlarged view of section IV in FIG. 3. FIG. 5 is a schematic view of an angle between a vibrating direction of a vibrating system and a top plane in FIG. 4. The speaker 100 of the present invention comprises a frame 1, a magnetic circuit system 2 and a vibrating system 3 both fixed on the frame 1.

The magnetic circuit system 2 includes a yoke 21 fixed on the frame 1, a main magnet 22, a main pole core 23 attached to an upper surface of the main magnet 22, secondary magnets 24 arranged surrounding the main magnet 22 and a secondary pole portion 25 attached to an upper surface of the secondary magnet 24. Both the main magnet 22 and the secondary magnet 24 are fixed on the yoke 21, wherein the main magnet 22 is located in the middle of the yoke 21, the secondary magnet 24 is located on both sides of the main magnet 22 and spaced apart from the main magnet 22 for forming a magnetic gap.

In the embodiment, the secondary pole portion 25 is an annular configuration which matches with the shape of the frame 1, and the secondary pole portion 25 is fixed to the frame 1. Specifically, a straight line L is parallel to the vibrating direction of the vibrating system 3. The secondary pole portion 25 is provided with locating holes 251 penetrating the secondary pole portion 25 along the vibrating direction of the vibrating system 3. Locating blocks 11 are arranged on the position of frame 1 corresponding to the locating holes 251, and the locating blocks 11 are fixed on the locating holes 251, respectively. Specifically, the secondary pole portion 25 includes two longitudinal sides 252 opposite to each other and two lateral sides 253 for forming an annular shape together with the two longitudinal sides 252. The locating holes 251 are arranged on the longitudinal sides 252.

In the embodiment, the secondary magnet 24 includes a magnetic extending portion 241 extending along an intermediate position of the longitudinal side 252 thereof toward the main magnet 22 and spaced apart from the main magnet 22. The secondary pole portion 25 includes a pole extending portion 254 arranged on the magnetic extending portion 241, and the pole extending portion 254 extends horizontally from the secondary pole portion 25 along the intermediate position of the longitudinal side 252 thereof toward the main magnet 22. The volume of the secondary pole portion 25 is increased greatly with the above structure, thus the magnetic field intensity between the magnetic circuit system 2 and the vibrating system 3 is improved.

The vibrating system 3 includes a diaphragm 31, a voice coil 32, an auxiliary diaphragm 33, and a suspension 34. The diaphragm 31 is fixed above the frame 1. The voice coil 32 is fixed below the diaphragm 31 and inserted into the magnetic gap to generate electromagnetic force with the magnetic circuit system 2 after being provided with electric power, thereby driving the diaphragm 31 to vibrate and produce sound. The auxiliary diaphragm 33 is fixed on the suspension 34, one end of the suspension 34 is fixed on the voice coil 32, and the other end is fixed on the frame 1. The suspension 34 is located between the yoke 21 and the frame 1.

It should be noted that the frame 1 includes a side wall 12 for forming a receiving space 1C, and the side wall 12 includes a top plane 121 fixedly connected with the diaphragm 31. An angle between the top plane 121 and a vibrating direction of vibrating system 3 close to both the receiving space 1C and the diaphragm 31 is α, and the α is an acute angle or an obtuse angle. An effective bonding width of the top plane 121 and the diaphragm 31 can be widened via the above structure.

The diaphragm 31 includes a vibrating portion 311, a middle portion 312 arranged on an inner circumference of the vibrating portion 311, a transition portion 313 arranged on an outer circumference of the vibrating portion 311, and a fixing portion 314 connected to the transition portion 313. The surface of the fixing portion 314 matches with the shape of the top plane 121, and the diaphragm 31 is fixed on the frame 1 by gluing, that is, the top plane 121 is fixed on the fixing portion 314 by gluing.

Specially, the top plane 121 includes an inner edge 121a arranged close to the voice coil 32 and an outer edge 121b arranged away from the voice coil 32. When the α is an acute angle, the fixing portion 314 extends from the inner edge 121a toward the outer edge 121b and toward a direction of the diaphragm 3. When the α is an obtuse angle, the fixing portion 314 extends from the inner edge 121a toward the outer edge 121b and toward a direction away from the diaphragm 31.

Compared with the related art, in the speaker of the present invention, the angle between the top plane and the vibrating direction of the vibrating system close to both the receiving space and the diaphragm is configured as an acute angle or an obtuse angle. Therefore an effective bonding width of the frame and the diaphragm is increased and a fixing strength between the both is strengthened, thus the possibility of the frame falling off and separating from the diaphragm is reduced, thereby improving a structural reliability and stability of the speaker provided by the present invention.

The above is only preferred embodiment of the present invention, it should be noted that those skilled in the art can still make improvements without departing from the inventive concept, but these are all belongitudinal to the protection scope of the present invention.

What is claimed is:

1. A speaker, comprising a frame, a vibrating system and a magnetic circuit system fixed on the frame, the vibrating system comprising a diaphragm fixed on the frame and a voice coil for driving the diaphragm for vibrating and producing sound;
wherein, the frame includes side wall for forming a receiving space, the side wall includes a top plane fixedly connected with the diaphragm, an angle between the top plane and a vibrating direction of the vibrating system close to both the receiving space and the diaphragm is an obtuse angle or an acute angle.

2. The speaker according to claim 1, wherein the diaphragm includes a vibrating portion, a middle portion located on an inner circumference of the vibrating portion, a fixing portion fixedly connected with the top plane and a transition portion arranged on an outer circumference of the vibrating portion and connected the vibrating portion with the fixing portion, a surface of the fixing portion matches the shape of the top plane.

3. The speaker according to claim 2, wherein the angle is an obtuse angle, the top plane includes an inner edge arranged close to the voice coil and an outer edge arranged away from the voice coil, and the fixing portion extends from the inner edge toward the outer edge and toward a direction of the diaphragm.

4. The speaker according to claim 2, wherein the angle is an acute angle, the top plane includes an inner edge arranged close to the voice coil and an outer edge arranged away from the voice coil, and the fixing portion extends from the inner edge toward the outer edge and away from the direction of the diaphragm.

5. The speaker according to claim 1, wherein the magnetic circuit system includes a yoke fixed on the frame, a main magnet fixed on the yoke, a secondary magnet arranged surrounding the main magnet and a secondary pole portion attached to the surface of the secondary magnet; the secondary pole portion is an annular configuration that matches with the shape of the frame and the secondary pole portion is fixedly connected with the frame.

6. The speaker according to claim 5, wherein the secondary pole portion is provided with locating holes penetrating the secondary pole portion along the vibrating direction of the vibrating system, locating blocks matching with the shape of the locating holes are arranged on the position of the frame corresponding to the locating holes, and the locating blocks are fixed on the locating holes.

7. The speaker according to claim 6, wherein the secondary pole portion includes two longitudinal sides spaced apart from each other and two lateral sides for forming a ring structure together with the two longitudinal sides, the locating holes are arranged on the longitudinal sides of the secondary pole.

8. The speaker according to claim 7, wherein the secondary magnet includes a magnetic extending portion extending along an intermediate position of the longitudinal side thereof toward the main magnet and spaced apart from the main magnet; the secondary pole portion includes a pole extending portion arranged on the magnetic extending portion, the pole extending portion horizontally extends from the secondary pole portion along an intermediate position of the longitudinal side thereof toward the main magnet.

9. The speaker according to claim 1, wherein the diaphragm is fixed on the frame by gluing.
